(19) United States
(12) Patent Application Publication
(10) Pub. No.: US 2010/0177350 A1
(43) Pub. Date: Jul. 15, 2010

(54) IMAGE FORMING SYSTEM AND TERMINAL DEVICE INCLUDED IN THE SAME

(75) Inventor: Eiji Minami, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/686,981

(22) Filed: Jan. 13, 2010

(30) Foreign Application Priority Data
Jan. 14, 2009 (JP) 2009-005869

(51) Int. Cl. G06F 15/00

(52) U.S. Cl. 358/1.15

(57) ABSTRACT

An image forming system includes a first terminal device and a second terminal device. The first terminal device includes a storing unit that stores image data, a network connecting unit for establishing a connection with another terminal device through the Internet, an inputting unit that accepts input of a facsimile number of the second terminal device, a producing unit that produces peer-to-peer connection information for establishing a peer-to-peer connection with the second terminal device using the network connecting unit, and a facsimile transmitter that transmits the peer-to-peer connection information over telephone lines to the second terminal device in accordance with the facsimile number whose input is accepted by the inputting unit. The second terminal device includes a facsimile receiver that receives the peer-to-peer connection information over the telephone lines from the first terminal device, a network connecting unit that establishes a peer-to-peer connection with the first terminal device through the Internet in accordance with the received peer-to-peer connection information and acquires from the first terminal device image data stored in the storing unit, and a printer that performs printing on the basis of the received image data.

### BACKGROUND

1. Technical Field

The present invention relates to an image forming system that connects a plurality of terminal devices (image forming devices) over a network and a terminal device that is included in the image forming system.

2. Related Art

Image forming systems that connect a plurality of image forming devices (e.g., multifunction machines) over networks have become widely used. In such an image forming system, image data is transferred from an image forming device on the transmission side to an image forming device on the reception side, thereby enabling the image data to be output by the image forming device on the reception side.

For example, JP-A-2008-278177 proposes a technique of delivering (transmitting) image data (advertisement information) by mail from a terminal device (a facsimile device) on the transmission side over a public switched telephone network and through a fax-mail converter to a terminal device (a cellular phone) on the reception side.

Moreover, Internet facsimile systems that connect facsimile devices over the Internet so as to transmit and receive image data over the Internet have already become commercially practical.

As described above, transmission of image data over the Internet has already been performed in an Internet facsimile system as an existing image forming system.

In the existing Internet facsimile system, however, image data cannot be transmitted via the Internet unless, in the party on the transmission side, an IP address of the party on the other end (on the reception side) has been registered.

### SUMMARY

An advantage of the invention is that it provides a terminal device with a facsimile communication function of being able to transmit image data via the Internet without registering an IP address of the party on the reception side, and an image forming system using the terminal device.

An image forming system according to an embodiment of the invention includes a first terminal device and a second terminal device. The first terminal device includes a storing unit that stores image data, a network connecting unit for establishing a connection with another terminal device through the Internet, an inputting unit that accepts input of a facsimile number of the second terminal device, a producing unit that produces peer-to-peer connection information for establishing a peer-to-peer connection with the second terminal device using the network connecting unit, and a facsimile transmitter that transmits the peer-to-peer connection information over telephone lines to the second terminal device in accordance with the facsimile number whose input is accepted by the inputting unit. The second terminal device includes a facsimile receiver that receives the peer-to-peer connection information over the telephone lines from the first terminal device, a network connecting unit that establishes a peer-to-peer connection with the first terminal device through the Internet in accordance with the received peer-to-peer connection information and acquires from the first terminal device image data stored in the storing unit, and a printer that performs printing on the basis of the received image data.

Thus, in an image forming system using a terminal device with a facsimile communication function, image data can be transmitted via the Internet without registering of an IP address of the party on the reception side.

In a preferred embodiment, the peer-to-peer connection information may include authentication information for authentication of the second terminal device by the first terminal device.

In a preferred embodiment, the network connecting unit of the second terminal device may transmit a reception completion notice to the first terminal device upon completion of receiving the image data, and the first terminal device may protect the image data from being erased from the storing unit at least during the period from start of transmitting the image data of the storing unit to receiving the reception completion notice.

In a preferred embodiment, a scanner that scans an image and stores data of the scanned image in the storing unit may be further included.

In a preferred embodiment, a card reader to which a memory card is connectable may be further included. The card reader may store in the storing unit image data read from the memory card.

A terminal device according to an embodiment of the invention includes a storing unit that stores image data, a network connecting unit for establishing a connection with another terminal device through the Internet, an inputting unit that accepts input of a facsimile number of a terminal device on the reception side, a producing unit that produces peer-to-peer connection information for establishing a peer-to-peer connection with the terminal device on the reception side using the network connecting unit, and a facsimile transmitter that transmits the peer-to-peer connection information over telephone lines to the terminal device on the reception side in accordance with the facsimile number whose input is accepted by the inputting unit. By using a peer-to-peer connection based on the peer-to-peer connection information, the terminal device on the reception side is caused to acquire image data stored in the storing unit.

A terminal device according to an embodiment of the invention includes a facsimile receiver, a network connecting unit and a printer. The facsimile receiver receives peer-to-peer connection information for establishing a peer-to-peer connection with a terminal device on the transmission side, over telephone lines from the terminal device on the transmission side. The network connecting unit establishes a peer-to-peer connection with the terminal device on the transmission side through the Internet, in accordance with the received peer-to-peer connection information, and acquires image data from the terminal device on the transmission side. The printer performs printing on the basis of the received image data.

### BRIEF DESCRIPTION OF THE DRAWINGS

The invention will be described with reference to the accompanying drawings, wherein like numbers reference like elements.

FIG. 1 is a block diagram of an image forming system according to an embodiment of the invention.

FIG. 2 is a flowchart of transmission and reception of image data performed by the image forming system of FIG. 1.

### DESCRIPTION OF EXEMPLARY EMBODIMENT

An embodiment of the invention will be described below with reference to the accompanying drawings.

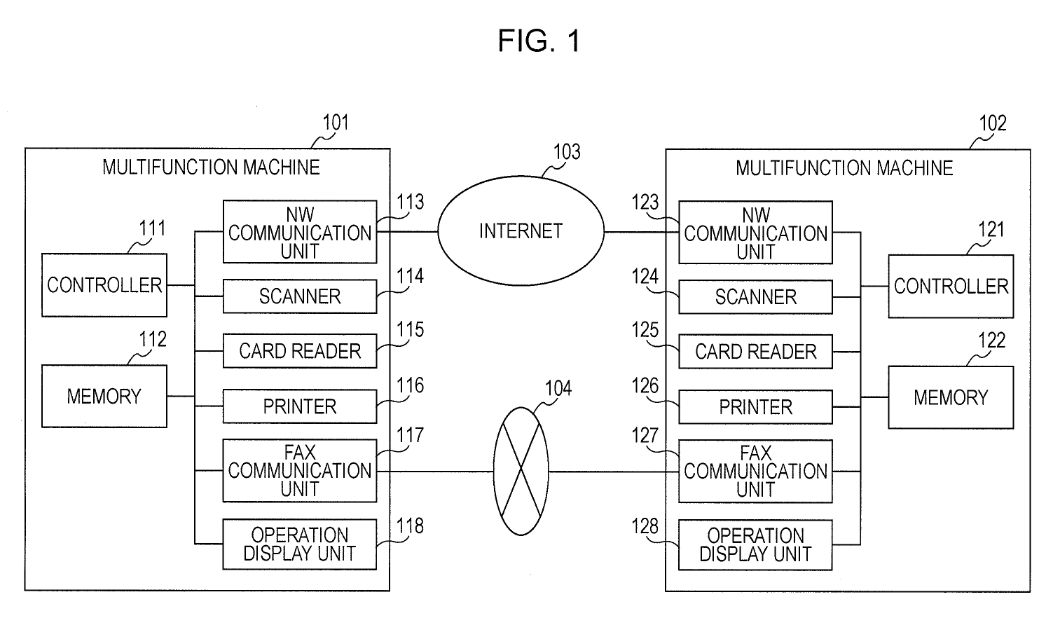

FIG. 1 is a block diagram of an image forming system according to an embodiment of the invention.

In FIG. 1, the image forming system is built such that a multifunction machine 101 and a multifunction machine 102, which function as terminal devices, are connected over the Internet 103 and a telephone network 104.

The multifunction machines 101 and 102, which have the same configuration, include controllers 111 and 121, memories (storing units) 112 and 122, network (NW) communication units (network connecting units) 113 and 123, scanners 114 and 124, card readers 115 and 125, printers 116 and 126, FAX communication units 117 and 127, and operation display units 118 and 128, respectively.

The multifunction machines 101 and 102 each have a scanner function, a printer function and a facsimile function because they include the scanners 114 and 124, the printers 116 and 126, and the FAX communication units 117 and 127.

The network communication units 113 and 123 are connected to each other through the Internet 103 so as to be able to perform Internet communication. The FAX communication units 117 and 127 are connected to each other through the telephone network 104 so as to be able to perform facsimile communication.

The controllers 111 and 121 control the network communication units 113 and 123, the scanners 114 and 124, the card readers 115 and 125, the printers 116 and 126, the FAX communication units 117 and 127, and the operation display units 118 and 128, respectively. The card readers 115 and 125, to which memory cards can be connected, store image data read from the memory cards into the memories 112 and 122, respectively.

In this embodiment, it is assumed that the multifunction machine 101 (first terminal device) is on the transmission side, and the multifunction machine 102 (second terminal device) is on the reception side.

In this case, the operation display unit 118 of the multifunction machine 101 on the transmission side (hereinafter referred to as the “transmission-side multifunction machine 101”) functions as an inputting unit that accepts input of a facsimile number of the second terminal device.

The controller 111 of the transmission-side multifunction machine 101 functions as a producing unit that produces peer-to-peer connection information for establishing a peer-to-peer connection between the network communication unit 113 of the transmission-side multifunction machine 101 and the network communication unit 123 of the multifunction machine 102 on the reception side (hereinafter referred to as the “reception-side multifunction machine 102”).

The FAX communication unit 117 of the transmission-side multifunction machine 101 functions as a facsimile transmitter that transmits the peer-to-peer connection information over the telephone network 104 to the reception-side multifunction machine 102 in accordance with the facsimile number whose input is accepted by the operation display unit 118.

The FAX communication unit 127 of the reception-side multifunction machine 102 functions as a facsimile receiver that receives the peer-to-peer connection information over the telephone network 104 from the transmission-side multifunction machine 101.

The network communication unit 123 of the reception-side multifunction machine 102 functions as a network connecting unit. The network connecting unit establishes a peer-to-peer connection with the network communication unit 113 of the transmission-side multifunction machine 101 over the Internet 103 on the basis of the received peer-to-peer connection information, and acquires image data stored in the memory 112 from the transmission-side multifunction machine 101.

The printer 126 of the reception-side multifunction machine 102 functions as a printer that performs printing on the basis of the received image data.

Here, the peer-to-peer connection information includes authentication information for authentication of the reception-side multifunction machine 102 by the transmission-side multifunction machine 101.

Upon completion of the receiving of the image data, the network communication unit 123 of the reception-side multifunction machine 102 transmits a reception completion notice to the transmission-side multifunction machine 101. The transmission-side multifunction machine 101 protects the image data from being erased from the memory 112 at least during the period from start of transmitting image data of the memory 112 to receiving the reception completion notice.

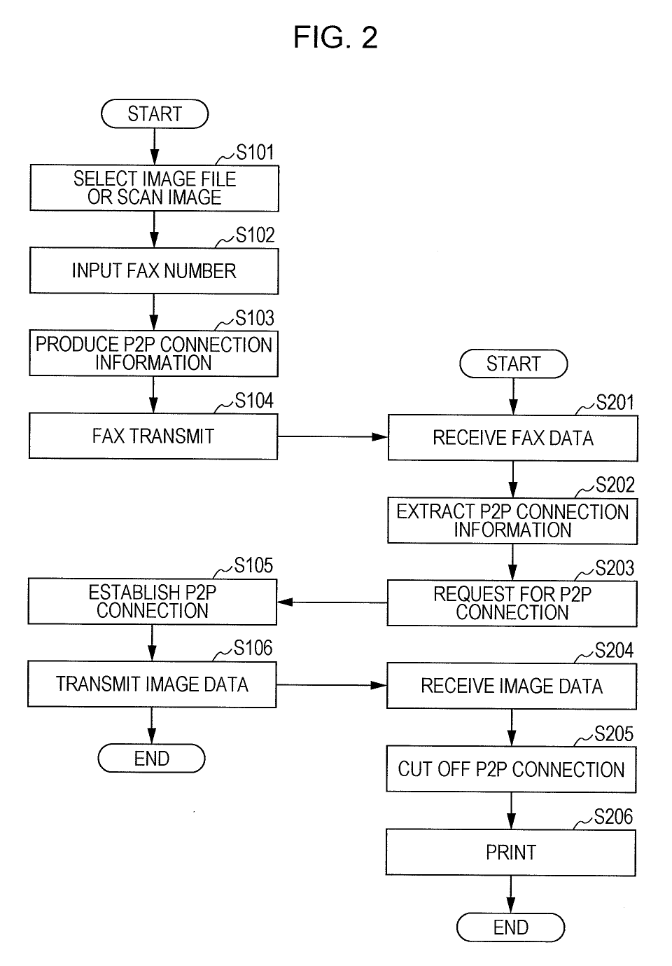

FIG. 2 is a flowchart of image data transmission and reception performed by the image forming system of FIG. 1. Each processing step is denoted by reference character S.

The processing on the transmission side (S 101 to S 106) in FIG. 2 is performed by the transmission-side multifunction machine 101 (first terminal device) and the processing on the reception side (S201 to 5206) is performed by the reception-side multifunction machine 102 (second terminal device).

First, in the processing on the transmission side, the controller 111 of the transmission-side multifunction machine 101 selects an image file stored in the memory 112, for example, in accordance with a user's instruction, or stores in the memory 112 an image file produced by scanning of an image by the scanner 114 and selects the image file (S101).

Next, the operation display unit 118 accepts input of a facsimile number of the reception-side multifunction machine 102, and the controller 111 recognizes the facsimile number (S102).

Next, the controller 111 produces peer-to-peer connection information for establishing a peer-to-peer connection with the reception-side multifunction machine 102 (S103). Included in the peer-to-peer connection information are, for example, an file name of the image file selected in step S101, and an IP address and a password of the multifunction machine 101.

According to the facsimile number whose input is accepted by the operation display unit 118, the FAX communication unit 117 transmits the peer-to-peer connection information produced in step S103 over the telephone network 104 to the reception-side multifunction machine 102 (S104).

The FAX communication unit 127 of the reception-side multifunction machine 102 receives FAX data transmitted from the transmission-side multifunction machine 101 (S201), and extracts the peer-to-peer connection information (S202).

On the basis of the peer-to-peer connection information extracted in step S202, the network communication unit 123 requests the transmission-side multifunction machine 101 to establish a peer-to-peer connection (S203). For example, the network communication unit 123 transmits an acquisition request for the image file having the file name included in the peer-to-peer connection information to the transmission-side multifunction machine 101 identified with the IP address included in the peer-to-peer connection information. At this point, the network communication unit 123 may transmit the password included in the peer-to-peer connection information and the facsimile number of the multifunction machine 102, in addition to the acquisition request, to the transmission-side multifunction machine 101 in order to receive authentication.

In response to the request for a peer-to-peer connection in step S203, the network communication unit 113 of the transmission-side multifunction machine 101 establishes a peer-to-peer connection with the reception-side multifunction machine 102 over the Internet 103 (S105). The controller 111 may authenticate the reception-side multifunction machine 102 on the basis of the information (the password and the facsimile number) received by the network communication unit 113.

Next, the network communication unit 113 transmits the image data stored in the memory 112, which is selected in step S101, over the Internet 103 to the reception-side multifunction machine 102 (S106).

On the basis of the received peer-to-peer connection information, the network communication unit 123 of the reception-side multifunction machine 102 receives (acquires) the image data transmitted by way of the peer-to-peer connection over the Internet 103 from the multifunction machine 101 (S204). Upon completion of the receiving of the image data by the network communication unit 123, a completion notice may be given to the network communication unit 113.

After the receiving of the image data, the network communication unit 123 cuts off the peer-to-peer connection (S205). Then the printer 126 carries out printing on the basis of the received image data (S206).

As described above, according to this embodiment of the invention, the transmission-side multifunction machine 101 can transmit image data over the Internet 103 even if the transmission-side multifunction machine 101 does not hold an IP address of the reception-side multifunction machine 102. Thus, an output matter with excellent image quality can be obtained in the reception-side multifunction machine 102.

What is claimed is:

1. An image forming system comprising a first terminal device and a second terminal device, wherein
the first terminal device includes:
a storing unit that stores image data;
a network connecting unit for establishing a connection with another terminal device through the Internet;
an inputting unit that accepts input of a facsimile number of the second terminal device;
a producing unit that produces peer-to-peer connection information for establishing a peer-to-peer connection with the second terminal device using the network connecting unit; and
a facsimile transmitter that transmits the peer-to-peer connection information over telephone lines to the second terminal device in accordance with the facsimile number whose input is accepted by the inputting unit; and
the second terminal device includes:
a facsimile receiver that receives the peer-to-peer connection information over the telephone lines from the first terminal device;
a network connecting unit that establishes a peer-to-peer connection with the first terminal device through the Internet in accordance with the received peer-to-peer connection information and acquires from the first terminal device image data stored in the storing unit; and
a printer that performs printing on the basis of the received image data.

2. The image forming system according to claim 1, wherein the peer-to-peer connection information includes authentication information for authentication of the second terminal device by the first terminal device.

3. The image forming system according to claim 1, wherein
the network connecting unit of the second terminal device transmits a reception completion notice to the first terminal device upon completion of receiving the image data; and
the first terminal device protects the image data from being erased from the storing unit at least during a period from start of transmitting the image data of the storing unit to receiving the reception completion notice.

4. The image forming system according to claim 1, further comprising a scanner that scans an image and stores data of the scanned image in the storing unit.

5. The image forming system according to claim 1, further comprising a card reader to which a memory card is connectable,
wherein the card reader stores in the storing unit image data read from the memory card.

6. A terminal device, comprising:
a storing unit that stores image data;
a network connecting unit for establishing a connection with another terminal device through the Internet;
an inputting unit that accepts input of a facsimile number of a terminal device on a reception side;
a producing unit that produces peer-to-peer connection information for establishing a peer-to-peer connection with the terminal device on the reception side using the network connecting unit; and
a facsimile transmitter that transmits the peer-to-peer connection information over telephone lines to the terminal device on the reception side in accordance with the facsimile number whose input is accepted by the inputting unit,
wherein, by using a peer-to-peer connection based on the peer-to-peer connection information, the terminal device on the reception side is caused to acquire image data stored in the storing unit.

7. A terminal device, comprising:
a facsimile receiver that receives peer-to-peer connection information for establishing a peer-to-peer connection with a terminal device on a transmission side, over telephone lines from the terminal device on the transmission side;
a network connecting unit that establishes a peer-to-peer connection with the terminal device on the transmission side through the Internet, in accordance with the received peer-to-peer connection information, and acquires image data from the terminal device on the transmission side; and
a printer that performs printing on the basis of the received image data.
